(19) United States
(12) Patent Application Publication
(10) Pub. No.: US 2013/0327148 A1
(43) Pub. Date: Dec. 12, 2013

(54) SYSTEMS AND METHODS FOR DAMAGE DETECTION IN PLATE-LIKE STRUCTURES USING GUIDED WAVE PHASED ARRAYS

(71) Applicant: FBS, Inc., State College, PA (US)

(72) Inventors: Fei Yan, State College, PA (US); Joseph L. Rose, State College, PA (US); Steven E. Owens, Bellefonte, PA (US)

(73) Assignee: FBS, Inc., State College, PA (US)

(21) Appl. No.: 13/901,786

(22) Filed: May 24, 2013

Related U.S. Application Data
(60) Provisional application No. 61/651,864, filed on May 25, 2012.

(51) Int. Cl. G01N 29/34

(52) U.S. Cl. CPC G01N 29/34
USPC 73/628

(57) ABSTRACT

A method for ultrasonic guided wave defect detection in a plate-like structure is disclosed. The method includes driving a plurality of transducers to cause guided waves to be transmitted in the plate in a predetermined direction or focused at a predetermined focal point, receiving at least one reflected guided wave signal, and processing the at least one reflected guided wave signal to identify a location of at least one possible defect in the plate-like structure. Defect detection data including the location of the at least one possible defect in the plate-like structure is stored in a machine readable storage medium.

### CROSS-REFERENCE TO RELATED APPLICATIONS

This application claims priority to U.S. Provisional Patent Application No. 61/651,864, filed May 25, 2012, the entirety of which is herein incorporated by reference.

### FIELD OF DISCLOSURE

The disclosed systems and methods relate to structural heath monitoring and non-destructive examination. More particularly, the disclosed systems and methods relate to structural heath monitoring and non-destructive examination of plates and plate-like structures using guided wave phased arrays.

### BACKGROUND

Various systems exist for structural heath monitoring (“SHM”) and/or non-destructive examination (“NDE”) of plates or plate-like structures like those used on pressure vessels, aircraft fuselage and wings, ship hulls and storage tanks to identify only a couple possible uses. However, these systems and monitoring/examination techniques are mostly based on point-to-point inspections and are not capable of performing rapid large area monitoring and/or inspection.

### SUMMARY

In some embodiments, an ultrasonic guided wave system for defect detection in a plate-like structure includes at least two guided wave transducers configured to be disposed on a plate-like structure and a controller electrically coupled to the at least two guided wave transducers. The controller includes a machine readable storage medium and a processor in signal communication with the machine readable storage medium. The processor is configured to cause a pulse generator to pulse the at least two guided wave transducers in accordance with at least one of time delays or amplitude controls such that guided wave energy is steered in a predetermined direction in the plate-like structure or is focused at a predetermined focal point, process at least one reflected guided wave signal to identify a location of at least one possible defect in the plate-like structure, and have defect detection data of the plate-like structure including the location of the at least one possible defect in the plate-like structure stored in the machine readable storage medium.

In some embodiments, a method for ultrasonic guided wave defect detection in a plate-like structure is disclosed. The method includes driving a plurality of transducers to cause guided waves to be transmitted in the plate-like structure in a predetermined direction or focused at a predetermined focal point, receiving at least one reflected guided wave signal, and processing the at least one reflected guided wave signal to identify a location of at least one possible defect in the plate-like structure. Defect detection data including the location of the at least one possible defect in the plate-like structure is stored in a machine readable storage medium.

In some embodiments, a system for ultrasonic guided wave defect detection in a plate-like structure includes a first sensor. The first sensor includes a housing defining an internal chamber and a block of d₁₅ piezoelectric material configured as a shear transducer disposed within the internal chamber defined by the housing. At least one conductive trace is electrically coupled to the block of d₁₅ piezoelectric material and is configured to couple the block of d₁₅ piezoelectric material to a voltage source for generating shear deformations of the block of d₁₅ piezoelectric material.

### BRIEF DESCRIPTION OF THE DRAWINGS

FIG. 1A illustrates one example of a non-destructive inspection system for inspecting plates and plate-like structures in accordance with some embodiments.

FIG. 1B illustrates one example of a portable non-destructive inspection or health monitoring system in accordance with FIG. 1A.

FIG. 1C illustrates one example of a housing for a circular array of transducers in accordance with some embodiments.

FIG. 1D illustrates one example of the transducers being assembled to the housing illustrated in FIG. 1C in accordance with some embodiments.

FIG. 1E illustrates one example of a wear plate affixed to the bottom surface of the array housing in accordance with some embodiments.

FIG. 1F illustrates one example of the transducers and leads coupled to the transducers being installed in a housing in accordance with some embodiments.

FIG. 1G is one example of a block diagram of a controller of the non-destructive inspection system illustrated in FIGS. 1A and 1B in accordance with some embodiments.

FIG. 2 illustrates one example of phase velocity dispersion curves for a zero degree fiber direction in a 16 layer quasi-isotropic composite plate.

FIG. 3 illustrates one example of an image obtained of a numerical simulation of guided wave energy being steered in a direction in a plate structure.

FIG. 4A illustrates one example of an experimental result of a phased array scanning image obtained by using the wave number domain back-propagation signal synthesis using a 16-element circular array mounted at the approximate center of the plate.

FIG. 4B is a picture of the array used to obtain the image illustrated in FIG. 4A.

FIGS. 4C-4F are detailed images of the defects detected in the image of FIG. 4A.

FIG. 5A illustrates one example of a guided wave CT, including the possible paths for a 16-element circular array network.

FIG. 5B illustrates one example of guided wave signals between a first transducer pair in FIG. 5A before a corrosion and after a corrosion.

FIG. 5C illustrates one example of guided wave signals between a second transducer pair in FIG. 5A before a corrosion and after a corrosion.

FIG. 6A illustrates an example of a “hidden” surface on a 4 ft.×4 ft. aluminum plate with a 16-sensor linear array mounted on the plate.

FIG. 6B illustrates an example of an “exposed” surface on a 4 ft.×4 ft. aluminum plate with two simulated corrosion defects show at the right of the figure.

FIG. 7A illustrates an example of a CT image showing the detection and imaging of Defect 1 in FIG. 6B.

FIG. 7B illustrates an example of a CT image showing the detection and imaging of Defect 2 in FIG. 6B.

FIG. 7C illustrates an example of a CT image showing the detection and imaging of both Defect 1 and Defect 2 in FIG. 6B.

FIGS. 8A and 8B illustrate examples of outside-in focusing tomography sensors in accordance with some embodiments.

FIG. 9 illustrates one example of using tomography sensors to improve the performance of a phased array.

FIG. 10A illustrates one example of a shear sensor in accordance with some embodiments.

FIG. 10B is a high level circuit diagram of a sensor illustrated in FIG. 10A being coupled to an AC power supply in accordance with some embodiments.

FIG. 11A illustrates one example of a shear sensor setup for corrosion detection under a water loading condition.

FIG. 11B illustrates one example of a corrosion detection result obtained using a shear sensor setup under the water loading condition in accordance with FIG. 11A.

FIG. 11C illustrates one example of a PZT disk sensor setup under a water loading condition.

FIG. 11D illustrates one example of a corrosion detection result obtained using a PZT disk sensor setup in accordance with FIG. 11C.

FIG. 12 illustrates one example of a circular shear PZT element array including 16 elements in accordance with some embodiments.

FIG. 13A illustrates one example of the results obtained for a corrosion defect at its stage 1 with no water as detected by the array illustrated in FIG. 12.

FIG. 13B illustrates one example of the results obtained for a corrosion defect at its stage 2 with no water as detected by the array illustrated in FIG. 12.

FIG. 13C illustrates one example of the results obtained for a corrosion defect at its stage 3 with no water as detected by the array illustrated in FIG. 12.

FIG. 13D illustrates one example of the results obtained for a corrosion defect at its stage 1 with water as detected by the array illustrated in FIG. 12.

FIGS. 14A and 14B illustrate scanning images of a representation of a ship hull structure using a pulse-echo phase array probe in accordance with FIG. 1B.

FIG. 15A illustrates one example of angular dependence of out-of-plane displacement of mode 3 at a frequency of 600 kHz excited by a unit out-of-plane point source.

FIG. 15B illustrates one example of angular dependence of out-of-plane displacement of mode 1 at a frequency of 160 kHz excited by a unit out-of-plane point source.

FIG. 16A illustrates one example of phased array beam steering of mode 3 at 600 kHz at a 113 degree beam steering direction.

FIG. 16B illustrates one example of phased array beam steering of mode 1 at 160 kHz at a 110 degree beam steering direction.

FIG. 17 illustrates one example of an 8-element sensor array including a rod sensing element for exciting mode 1 in a composite plate at 100 kHz.

FIG. 18A illustrates a comparison between experimental results and a calculated array defectivity profile for a beam steering angle of zero degrees.

FIG. 18B illustrates a comparison between experimental results and a calculated array defectivity profile for a beam steering angle of 60 degrees.

FIG. 18C illustrates a comparison between experimental results and a calculated array defectivity profile for a beam steering angle of 120 degrees.

FIG. 19 is a flow diagram of one example of a method of performing structural health monitoring and/or non-destructive evaluation of plates and plate-like structures in accordance with some embodiments.

FIG. 20A illustrates one example of a diagram from use in calculating time delays for steering guided wave energy into a predetermined direction in accordance with some embodiments.

FIG. 20B illustrates one example of a diagram for use in calculating time delays for focusing guided waves at a predetermined location in accordance with some embodiments.

### DETAILED DESCRIPTION

This description of the exemplary embodiments is intended to be read in connection with the accompanying drawings, which are to be considered part of the entire written description.

Ultrasonic guided waves have shown good potential for SHM and/or NDE of plates or plate-like structures due to their capability of interrogating a large area with a small number of transducer locations. The system and methods disclosed herein utilize a real time phased array concept with specially designed guided wave transducers to produce large area SHM and/or NDE of plates or plate-like structures with improvements on guided wave penetration power, signal-to-noise-ratio (SNR), and defect detection sensitivity. As used herein, the term “plate-like structure” includes plates and refers to a structure confined by two planar or curved surfaces including, but not limited to, those used on pressure vessels, aircraft fuselages and wings, ship hulls, and storage tanks, to list only a few examples.

In some embodiments, the system includes a plurality of ultrasonic guided wave transducers, which can be excited individually and/or simultaneously. In some embodiments, the guided wave transducers are placed closely together on the structure to form a compact array. In some embodiments, the guided wave transducers are distributed on the structure at a distance from each other in a random or orderly configuration. The system includes a number of pulser and receiver channels. Time delays and possible amplitude factors can be input into each pulser channel for steering the guided wave energy in a specific direction or to focus the energy at a specific location in the structure. In some embodiments, guided wave phased array techniques are combined with the guided wave computational tomography (“CT”) techniques for damage imaging.

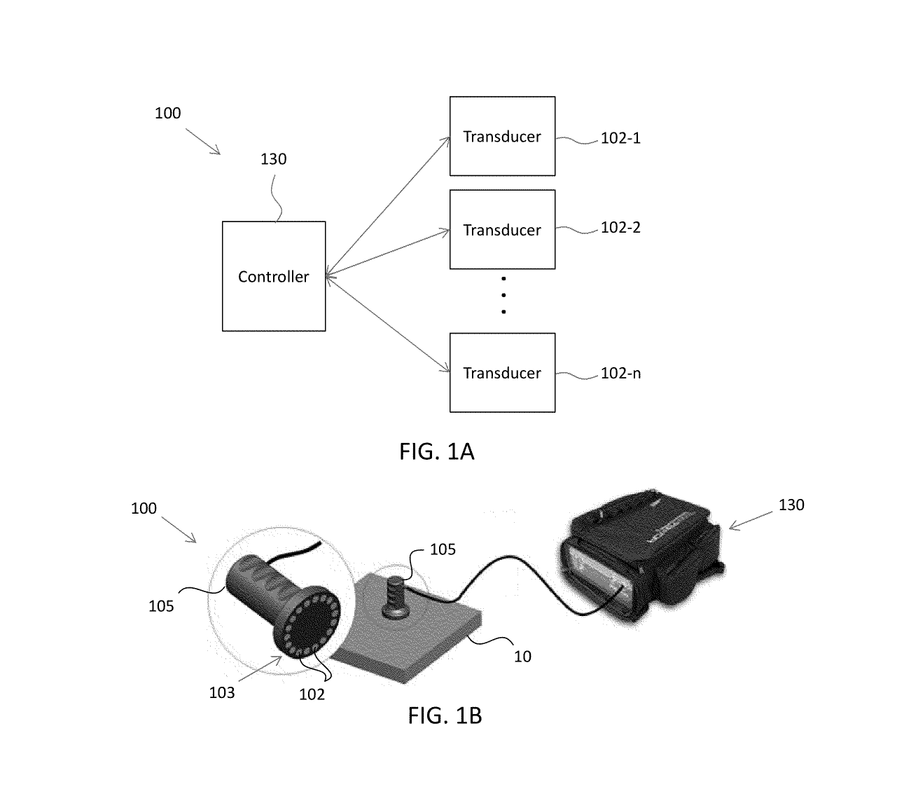

FIGS. 1A-1G illustrate one example of a non-destructive inspection system 100 configured to inspect plates and plate-like structures using guided wave phased arrays. As shown in FIG. 1A, inspection system 100 includes a number, n, of transducers 102-1, 102-2, . . . , 102-n (collectively “transducers 102”) communicatively coupled to a controller 130. In some embodiments, as described below, system 100 is a portable system in which the transducers 102 are not fixedly connected to a plate or plate-like structure, and in some embodiments, system 100 is a “fixed” system in which the transducers are secured in some manner to a plate or plate-like structure. These transducers 102 can be piezoelectric stack transducers, shear piezoelectric transducers, electrical magnetic acoustic transducers (“EMATs”), or other suitable transducer as will be understood by one of ordinary skill in the art. Transducers 102 can be configured as a transmitter or a receiver in a through-transmission setup. Each of the transducers 102 can also be used as a dual mode transducer under a pulse-echo test mode.

In some embodiments, such as the embodiment in FIG. 1B, a plurality of transducers 102 are arranged in circular phased array 103 disposed in a body or housing 104 of a probe 105 such that the array 103 is portable such that the probe 105 can be placed in contact with plate or plate-like structure 10, be moved around structure 10, and be removed from contact with structure 10. As shown in FIG. 1B, probe 105 is tethered to controller 130. Each of the sensing elements, e.g., transducers 102, can be disposed around body 104 at an equal distance from the directly adjacent sensing elements. In some embodiments, transducers 102 are equally spaced about body 104.

FIG. 1C illustrates one example of a housing 104 prior to transducers 102 being installed. As shown in FIG. 1C, housing 104 includes a plurality of holes or internal chambers 106 arranged in a circle near the peripheral edge 108 of housing 104. In some embodiments, housing 104 is formed from Noryl; however, housing 104 can be formed from other materials including, but not limited to, rubber, metal, and plastic to list a few possible alternative materials. Holes and/or internal chambers 106 can be formed by drilling, milling, injection molding housing 104 with holes 106, or by any other suitable manufacturing method. Although a plurality of holes/internal chambers 106 are illustrated, a single hole or internal chamber 106 can be provided and a plurality of transducers can be disposed therein in some embodiments. Housing 104 also defines a slot 108 at the approximate center with a central hole 110 defined within slot 108.

Bottom surface 112 of housing 104 is covered, at least partially, with a conductive epoxy 114 as shown in FIG. 1D, and then is covered with a wear plate 116 as illustrated in FIG. 1E. In some embodiments, wear plate 116 is formed from a metal material, such as aluminum, although one of ordinary skill in the art will understand that other materials can be used. A ground lead (not shown) may be placed within central hole 110.

Turning now to FIG. 1F, transducers 102 are inserted into holes 106 and sealed therein by epoxy 114. A lead wire 118 is connected to each transducer 102 and, in some embodiments, are tied together in a bundle 120. In some embodiments, the transducers 102 are thin piezoelectric disks, piezoelectric cylinders, cuboid piezoelectric elements, magnetostrictive transducers, such as those disclosed in commonly assigned U.S. patent application Ser. No. 13/298,758, which is incorporated herein by reference in its entirety, EMATs, or other suitable transducer. In some embodiments, the phased array 103 is made from a piece of piezoelectric composite material with an array of electrode patterns. The piezoelectric composite material is enclosed in a housing enclosure with appropriate wiring, transducer backing, matching, and wear plates as will be understood by one of ordinary skill in the art.

Referring now to FIG. 1G, controller 130 includes one or more processors, such as processor(s) 132. Processor(s) 132 may be any central processing unit (“CPU”), microprocessor, micro-controller, or computational device or circuit for executing instructions and be connected to a communication infrastructure 134 (e.g., a communications bus, cross-over bar, or network). Various software embodiments are described in terms of this exemplary controller 130. After reading this description, it will be apparent to one of ordinary skill in the art how to implement the method using other computer systems or architectures.

In some embodiments, controller 130 includes a display interface 136 that forwards graphics, text, and other data from the communication infrastructure 134 (or from a frame buffer not shown) for display on a monitor or display unit 138 that is integrated with or separate from controller 130.

Controller 130 also includes a main memory 140, such as a random access memory (“RAM”), and a secondary memory 142. In some embodiments, secondary memory 142 includes a persistent memory such as, for example, a hard disk drive 144 and/or removable storage drive 146, representing an optical disk drive such as, for example, a DVD drive, a Blu-ray disc drive, or the like. In some embodiments, removable storage drive may be an interface for reading data from and writing data to a removable storage unit 148. Removable storage drive 146 reads from and/or writes to a removable storage unit 148 in a manner that is understood by one of ordinary skill in the art. Removable storage unit 148 represents an optical disc, a removable memory chip (such as an erasable programmable read only memory (“EPROM”), Flash memory, or the like), or a programmable read only memory (“PROM”)) and associated socket, which may be read by and written to by removable storage drive 146. As will be understood by one of ordinary skill in the art, the removable storage unit 148 may include a non-transient machine readable storage medium having stored therein computer software and/or data.

Controller 130 may also include one or more communication interface(s) 150, which allows software and data to be transferred between controller 130 and external devices such as, for example, transducers 102 and optionally to a mainframe, a server, or other device. Examples of the one or more communication interface(s) 150 may include, but are not limited to, a modem, a network interface (such as an Ethernet card or wireless card), a communications port, a Personal Computer Memory Card International Association (“PCMCIA”) slot and card, one or more Personal Component Interconnect (“PCI”) Express slot and cards, or any combination thereof. Software and data transferred via communications interface 150 are in the form of signals, which may be electronic, electromagnetic, optical, or other signals capable of being received by communications interface 150. These signals are provided to communications interface(s) 150 via a communications path or channel. The channel may be implemented using wire or cable, fiber optics, a telephone line, a cellular link, a radio frequency (“RF”) link, or other communication channels.

In this document, the terms “computer program medium” and “non-transient machine readable medium” refer to media such as removable storage units 148 or a hard disk installed in hard disk drive 144. These computer program products provide software to controller 130. Computer programs (also referred to as “computer control logic”) may be stored in main memory 140 and/or secondary memory 142. Computer programs may also be received via communications interface(s) 150. Such computer programs, when executed by a processor(s) 132, enable the controller 130 to perform the features of the method discussed herein.

In an embodiment where the method is implemented using software, the software may be stored in a computer program product and loaded into controller 130 using removable storage drive 146, hard drive 144, or communications interface(s) 150. The software, when executed by a processor(s) 132, causes the processor(s) 132 to perform the functions of the method described herein. In another embodiment, the method is implemented primarily in hardware using, for example, hardware components such as application specific integrated circuits (“ASICs”). Implementation of the hardware state machine so as to perform the functions described herein will be understood by persons skilled in the art. In yet another embodiment, the method is implemented using a combination of both hardware and software.

Controller 130 also includes a pulse generator 152 configured to output a variety of pulses to transducers 102. For example, pulse generator 152 may transmit time-delayed control signals to transducers 102, and/or pulse generator 152 may transmit control signals of varying amplitudes to transducers 102.

An amplifier 154 is configured to amplify signals received from transducers 102. Such signals received by transducers 102 include reflections of waves from structural features and other anomalies, e.g., corrosion in a plate or plate-like structures, in response to signals transmitted by pulse generator 152. An analog to digital (“A/D”) converter 156 is coupled to an output of amplifier 154 and is configured to convert analog signals received from amplifier 154 to digital signals. The digital signals output from A/D converter 156 may be transmitted along communication infrastructure 134 where they may undergo further signal processing by processor(s) 132 as will be understood by one of ordinary skill in the art.

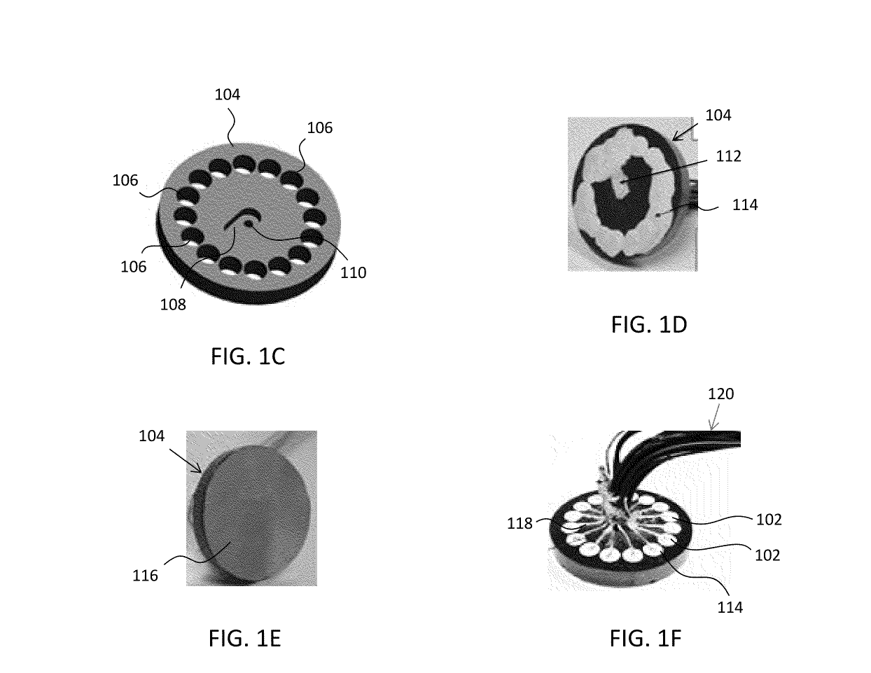

Turning now to FIG. 2, which illustrates one example of velocity dispersion curves for a zero degree fiber direction in a 16 layer quasi-isotropic composite plate with the first 8 modes by their respective numbers, i.e., 1, 2, 3, etc. There are infinite numbers of possible guided wave modes in a plate-like structure such as, for example, a composite plate. These wave modes in a plate have different phase and group velocities and energy distributions across the thickness, which may vary with frequency and/or excitation conditions. For guided wave beam steering or beam focusing, guided wave modes with similar velocities can be excited.

The guided wave modes with different velocities are considered as unwanted wave modes and may result in significant wave energy traveling to directions other than the desired beam steering direction or create energy focal points other than at the desired focal point. Furthermore, the velocity differences may introduce coherent noise in guided wave damage detection applications. For instance, if the pulse-echo method is used to detect a single defect, the received signal may have multiple reflected wave packets due to the existence of wave modes with different wave velocities. The redundant wave packets coming from the unwanted wave modes may cause false alarms. To avoid the influence of the unwanted wave modes, transducers with the capability of dominantly exciting guided wave energy with the desired wave velocity while minimizing the energy of the unwanted wave modes can be used. The design of such transducers can be carried out based on theoretical calculations. As described above, examples of such guided wave transducers include, but are not limited to, annular array transducers, time delay annular array transducers, piezoelectric elements on angle wedges, EMATs, and magetostrictive transducers, to list a few possibilities.

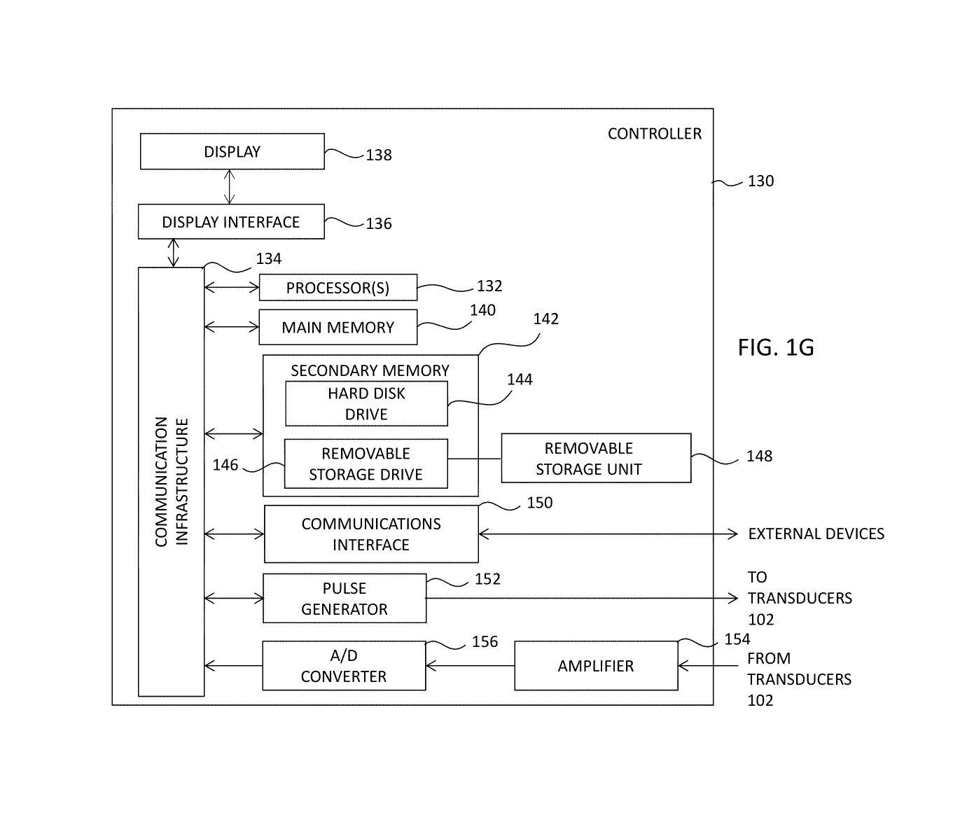

With the energy of unwanted wave modes controlled, time delays can be applied to the transducers 102 to perform phased array beam steering or focusing. Each transducer 102 in the array 103 excites guided wave energy that can propagate in any direction. As described above, pulse generator 152 can transmit time-delayed control signals to transducers 102 to physically focus guided waves at a focal point or to form a guided wave beam in a particular direction. The direction of wave propagation can be controlled via a “phasing” approach. FIG. 3 illustrates one example of the image obtained using a circular phased array of a portable system 100, such as an array 103 of probe 105 described above in accordance with FIGS. 1B-1F, inspecting an aluminum plate. As shown in FIG. 3, by applying time delays to the array 103, the individual transducer elements 102 can be “phased” in such a way to allow the guided wave energy to be steered in any direction.

The steering direction can then be controlled to allow 360° scanning. This is different from the guided wave array systems for plate structures that are presented in the articles “Tuned Lamb Wave Excitation and Detection with Piezoelectric Wafer Active Sensors for Structural Health Monitoring,” by V. Giugiutiu; “Directional Piezoelectric Phased Array Filters for Detecting Damage in Isotropic Plates,” by Purekar et al.; “Omni-Directional Guided Wave Transducer Arrays for the Rapid Inspection of Large Areas of Plate Structures,” by P. D. Wilcox; and “On the Development and Testing of a Guided Ultrasonic Wave Array for Structure Integrity Monitoring,” by Fromme et al., the entireties of which are incorporated by reference herein. In those systems, only one element of an array is pulsed at a time, and, as a result, there are no physically formed guided wave beams. The “beam steering” or “focusing” of those arrays are conducted through post data acquisition signal processing only.

In contrast, the systems and methods disclosed herein generate a physically formed beam of guided wave energy and direct such physically formed beam to different directions by varying the phase delays applied to the different elements of the phased array in a so-called “real-time phased array approach.” Benefits of using the real-time phased array approach for guided wave inspection of plate structures include, but are not limited to, higher penetration power, better signal-to-noise ratio, and the capability of rapidly scan selected directions and/or locations, to list a few examples.

In some embodiments, hardware time delays are applied to a probe to physically form guided wave beams for different beam steering directions, and a back propagation wave number domain signal synthesis approach is utilized for the syntheses of both the pulse-echo signals received by the elements 102 of the phased array and the through-transmission signals received by the receiving array 103. The back propagation wave number domain signal synthesis approach can be used in favor of a delay-and-sum time domain approach. Using plate structures as an example and taking into account the guided wave dispersion and the wave divergence in the plate, the time signal at a point located in the far field of an array element can be approximately expressed as:

$${s}^{′} ( t ) = \frac{1}{\sqrt{x}} {\int }_{- ∞}^{∞} S ( ω ) {e}^{- i k ( ω ) x} d ω \qquad Eq . ( 1 )$$

### Where,

S(ω) is the Fourier transform of the time domain guided wave input signal;

x is the distance away from the array element; and

k represents the wave number.

The wave number k is a function of circular frequency ω for guided wave modes with dispersion. For the pulse-echo mode, the reflected guided wave signal introduced by a defect located in the far field of the array can then be approximately written as:

$${G}_{n} ( t ) = \frac{γδ}{{r}_{d}} {\int }_{- ∞}^{∞} S ( ω ) {e}^{- i k ( ω ) 2 {r}_{d}} {e}^{i k ( ω ) {d}_{n}} d ω \qquad Eq . ( 2 )$$

### Where,

where δ is the signal magnification coefficient introduced by the constructive interference of the signals generated by all of the phased elements;

γ is the reflection coefficient;

r_{d} is the distance from the defect to the center of the array;

the subscript n represents that the reflection is received by the nth array element; and

d denotes the propagation distance that needs to be compensated for beam steering to the angle where the defect locates.

The wave number domain signal synthesis of the signals described by Equation (2) can be conducted using the following equation:

$${\sum }_{n}^{ } {B}_{n } {G}_{n} ( t ) = \frac{γ δ N}{{r}_{d}} {\int }_{- ∞}^{∞} S ( ω ) {e}^{- i k ( ω ) 2 {r}_{d}} d ω \qquad Eq . ( 3 )$$

### Where,

N is the number of array elements, and

Bₙ is the back-propagation term:

Bₙ=e^{-ik(ω)d}^{ₙ} Eq. (4)

As shown in Equation (4), the dispersion relation of the guided wave modes is included in the back-propagation process so that the dispersion effects that could decrease defect detection resolution can be removed from the wave number domain synthesized signals. In some embodiments, Equation (3) can be implemented using Fast Fourier Transforms (“FFT”). The wave number domain signal synthesis is therefore also fast. An advanced deconvolution method can be combined with the real-time guided wave phased array and the wave number domain signal synthesis as well to suppress image artifacts caused by the side lobes of the phased array as disclosed in the Ph.D. thesis, “Ultrasonic Guided Wave Phased Array for Isotropic and Anisotropic Plates,” by F. Yan, the entirety of which is herein incorporated by reference.

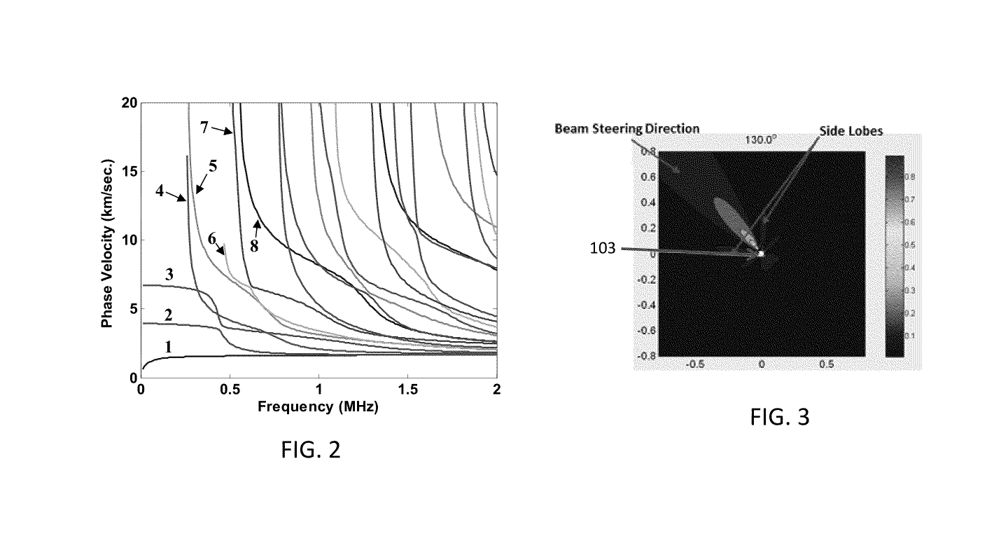

FIG. 4A illustrates one example of a phased array scanning image obtained in an experiment on a 4 ft.×4 ft. aluminum plate (1 mm thick) using the wave number domain signal synthesis with a fixed system 100 where the transducers 102 were secured to the plate 10. A 16-element circular array 103 was mounted or otherwise secured to the approximate center of the plate using epoxy 114 as illustrated in FIG. 4B. Lead wires 118 electrically connected array 103 to a controller 130 (not shown). The phased array was operated under a pulse-echo mode, and the locations and shapes of the defects are indicated in the image for comparison. As can be seen, defects 12, 14 16, and 18, which are shown in FIGS. 4C, 4D, 4E, and 4F, respectively, were well detected and located. A 5 mm hole 20 was also detected and is visible in the image.

In some embodiments, computed tomography (“CT”) imaging techniques, such as those disclosed in “Ultrasonic Guided Wave Tomography in Structural Health Monitoring of an Aging Aircraft Wing,” by Gao et al., and “Large Area Corrosion Detection in Complex Aircraft Components using Lamb Wave Tomography,” by Royer et al., the entireties of which are herein incorporated by reference, are used in combination with guided wave activation and reception to accurately detect and locate corrosion and cracking in plate and pipe structures using a small number of sensors to interrogate relatively large areas. Using such a technique, a set of base-line data is acquired and then compared to subsequent data sets, and a CT image is generated by comparing changes in the guided wave signals that occur from damage being introduced into the part.

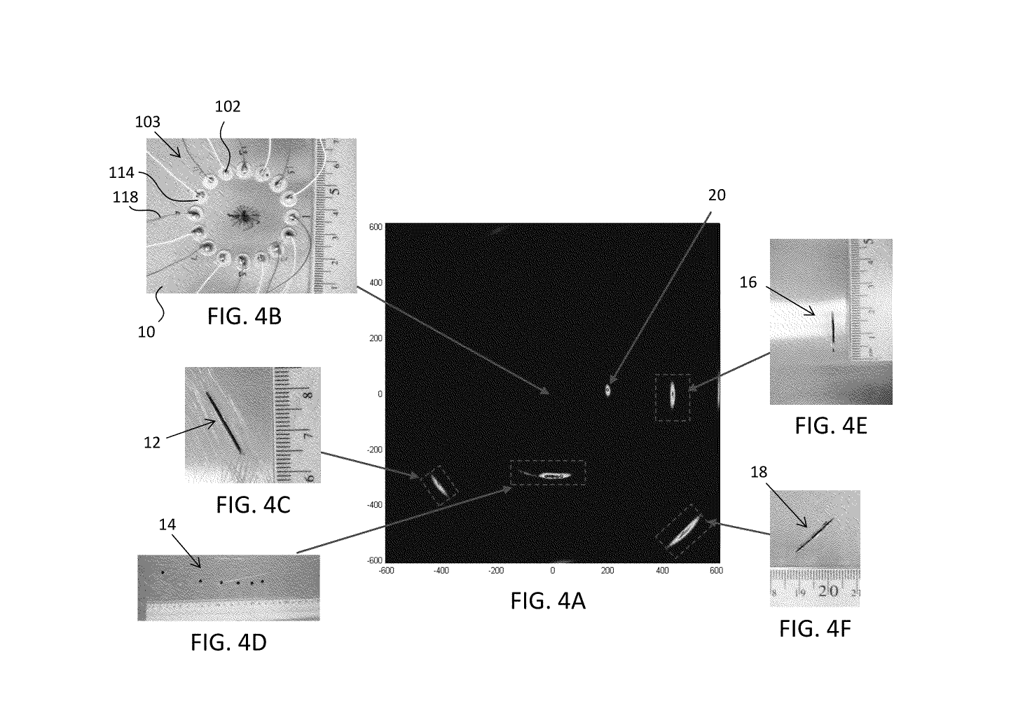

FIGS. 5A-5C illustrate one example of the guided wave CT concept. All possible guided wave paths for a 16-element guided wave actuator/sensor network are illustrated in FIG. 5A. The guided wave actuators/sensors can be piezoelectric disk transducers, annular array transducers, magnetostrictive transducers, EMATs, or other suitable actuator/sensor. For structural health monitoring (“SHM”) applications, base-line guided wave signals are collected for all wave paths. Subsequent data sets are acquired in the same manner over time. Guided wave signal variations can be observed when damage occurs in the area covered by the wave paths. Apparently, the signal variations for different sensor pairs will be different. For example, the sensor pair 102A-102B in FIG. 5A produces consistent signals before and after the corrosion damage occurs as illustrated in FIG. 5B. That is simply due to the fact that the corrosion damage is away from the wave path. In contrast, the sensor pair 102A-102C in FIG. 5A produces significant signal variations before and after the corrosion because the damage is located in the wave path as illustrated in FIG. 5C. The systems disclosed herein include guided wave CT algorithms that utilize the signal variations for different wave paths to reconstruct CT images that reveal the location, approximate size, and severity of possible damage to the structure under monitoring. The algorithms are applicable to sensor arrays with arbitrary sensor placements and also take into account guided wave beam divergence in plate-like structures. Examples of such algorithms are disclosed in “Ultrasonic Guided Wave Tomography in Structural Health Monitoring of an Aging Aircraft Wing,” by Gao et al., and “Large Area Corrosion Detection in Complex Aircraft Components using Lamb Wave Tomography,” by Royer et al., the entireties of which are herein incorporated by reference.

Different features of the guided wave signal, such as amplitude ratios of different modes and/or time of flight, can be input into the reconstruction algorithm, which is executed by processor(s) 132 of controller 130. Other features could come from a Fourier Transform, a short time Fourier Transform spectrogram, or a wavelet transform as examples. Different features are sensitive to different types of damage or material conditions.

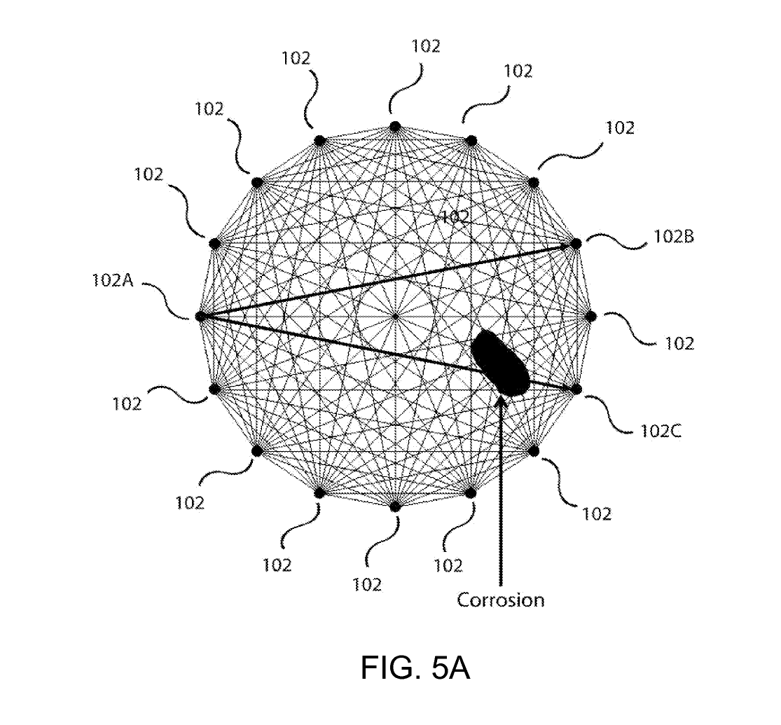

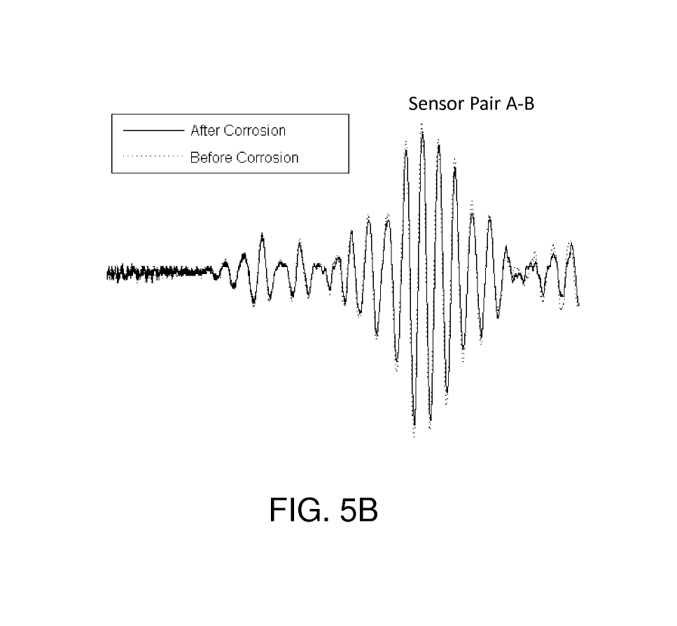

FIG. 6A illustrates one example of a first side 10A of a 4 ft. by 4 ft. aluminum plate 10 on which 16 packaged piezoceramic sensors 102 are fixedly mounted (using epoxy or other adhesive) and electrically connected to a controller 130 (not shown) via leads 118. FIG. 6B illustrates the opposite side 10B of the aluminum plate 20, which includes first and second defects, i.e., Defect 1 and Defect 2, respectively. FIGS. 7A-7C illustrate sample results of data that were acquired before and after introducing the simulated corrosion defects on the “exposed” surface FIG. 6B, i.e., before and after Defect 1 and Defect 2 were formed. In particular, FIG. 7A illustrates an example of a CT image showing the detection and imaging of Defect 1 in FIG. 6, FIG. 7B illustrates an example of a CT image showing the detection and imaging of Defect 2 in FIG. 6, and FIG. 7C illustrates an example of a CT image showing the detection and imaging of both Defect 1 and Defect 2 in FIG. 6.

In some embodiments, piezoelectric disc transducers 102, and/or guided wave transducers 102 with guided wave mode and frequency selection capabilities are used as guided wave CT sensors. Examples of guided wave sensors 102 include, but are not limited to, annular array transducers, time delay annular array transducers, piezoelectric elements on angle wedges, EMATs, and magetostrictive transducers, to list just a few possibilities.

Ultrasonic guided wave signals taken from a guided wave CT system are generally complicated, and this is especially true when using guided wave CT for large area monitoring of structures with complex geometries, for instance, rivets, and stiffeners. The multiple guided wave scatterings and possible mode conversions at the geometry variations make guided wave signals hard to integrate. This is the main reason why most current guided wave CT systems use only the so-called damage indexes (“DI”) that are defined based on some overall changes in guided wave signals. An example of such a system is described in “Detection and Monitoring of Hidden Fatigue Crack Growth Using a Built-in Piezoelectric Sensor/Actuator Network: II. Validation Using Riveted Joints and Repair Patches,” by Ihn et al., the entirety of which is herein incorporated by reference.

With the controlled guided wave excitations provided by the guided wave transducers, the quality of the guided wave signals can be greatly increased, in the sense that the signals become much easier to integrate based on the knowledge of the guided wave inputs. Physically based guided wave features may then be extracted from the guided wave signals for damage detection and evaluation. Examples of such physically based features include, but are not limited to, amplitude ratios of different modes, mode conversions among different guided wave modes, phase shifts of a specific mode, TOF changes of different modes, and changes in dispersion characteristics, to list a few non-limiting examples.

Guided wave signals obtained with these types of transducers are easier to interpret due to the controlled guided wave input. However, because of possible wave scatterings and mode conversions which are actually quite common for structures with complex geometries such as rivets and stiffeners, advanced signal processing methods are used for accurate feature extractions. Many signal processing tools are available for guided wave signal analysis including, but not limited to, FFT based spectrogram, wavelet based scalogram, and Hilbert-Huang transform. Each of these signal processing techniques can be used to obtain time-frequency representations of guided wave signals for in-depth guided wave mode and frequency analyses.

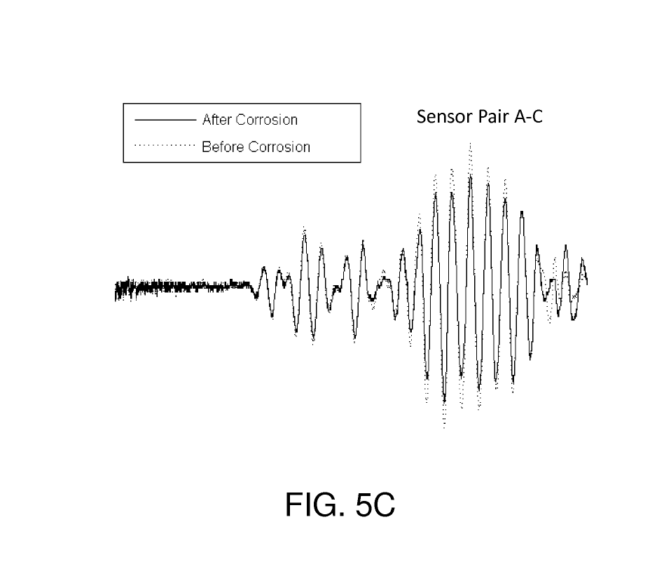

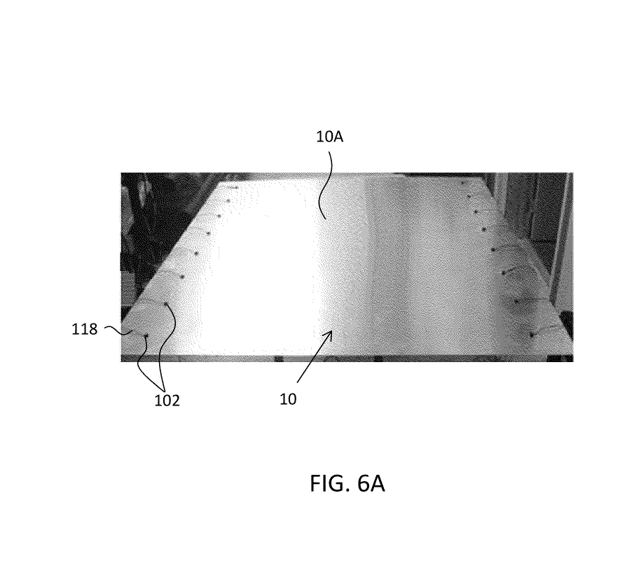

In some embodiments, the two technologies, guided wave phased array beam steering and guided wave tomography, can be combined together to provide more reliable damage detection and characterization as well as to potentially reduce the sensor density. FIGS. 8A, 8B, and 9 illustrate examples of the combination of the two technologies. Referring first to FIG. 8A, a plate-like structure 00 is provided with a plurality of sensors 102 being positioned about the periphery of plate 10.

As shown in FIGS. 8A and 8B, a number of sensors 102 are placed close to the boundary of the plate-like structure 10 for guided wave tomography tests. In some embodiments, tomography sensors 102 are thin piezoelectric disks, piezoelectric cylinders, cuboid piezoelectric elements, magnetostrictive transducers, and EMATs, to list a few possibilities. Using the phased array concept, different phase delays can be applied to the tomography sensors 102 by pulse generator 152 of controller 130 (not shown) to generate physical guided waves in a particular direction to focus from outside-in or from random locations, i.e., to achieve constructive interferences at different locations. The constructive interferences can increase the guided wave energy for damage interrogation and therefore will yield better penetration distance and more reliable damage detection results.

Phase delays may also be applied two or more of the tomography sensors 102 to focus guided wave energy to or close to the locations of other tomography sensors 102. Higher penetration power can be achieved with the phased array focusing. The phased delays may be applied to any tomography sensor groups. The locations of the focal points may be switched among different sensor locations as well. The received signals can be used for tomographic image reconstructions. In SHM applications, the “phasing” process can also be done with the residual signals that are calculated by subtracting base-line signals from the subsequently acquired signals. These calculations can be performed by processor(s) 132 of controller 130 as will be understood by one of ordinary skill in the art.

In FIG. 9, a plate or plate-like structure 10 is monitored using both tomography sensors 102-1 placed close to the plate edges and a probe 105 (not shown) including a phased array 103 of transducers 102-2 located near the center of the plate 10. Transducers 102-2 of array 103 is used to direct guided wave energy 30 in different directions by steering the energy as described above. At least some of the guided wave energy is reflected or scattered by a Damage/Defect in plate 10. This reflected/scattered guided wave energy, which is referenced by reference numeral 32, can be detected by tomography sensors 102-1. Thus, the combination of tomography sensors 102-1 and array 103 increase the probability of detection of scattered guided wave energy 32, which is reflected/scattered at different angles. All scattered guided waves can be well recorded. Again, a phasing process may be applied to the signals received by the tomography sensors 102-1 to further improve the inspection results.

System 100 can also be used to inspect plate and plate-like structures that are subject to water loading conditions, such as ship hulls, storage tank floors, and the like. In such embodiments, guided wave transducers 102 are designed such that they will excite and/or receive guided wave energies that do not leak into water. Shear horizontal (“SH”) type guided waves with pure shear particle displacements on the structure surfaces do not leak into water and therefore are one example of a suitable transducer 102 for this type of application. Longitudinal type waves with dominant in plane displacement on the surface of a structure may also be used.

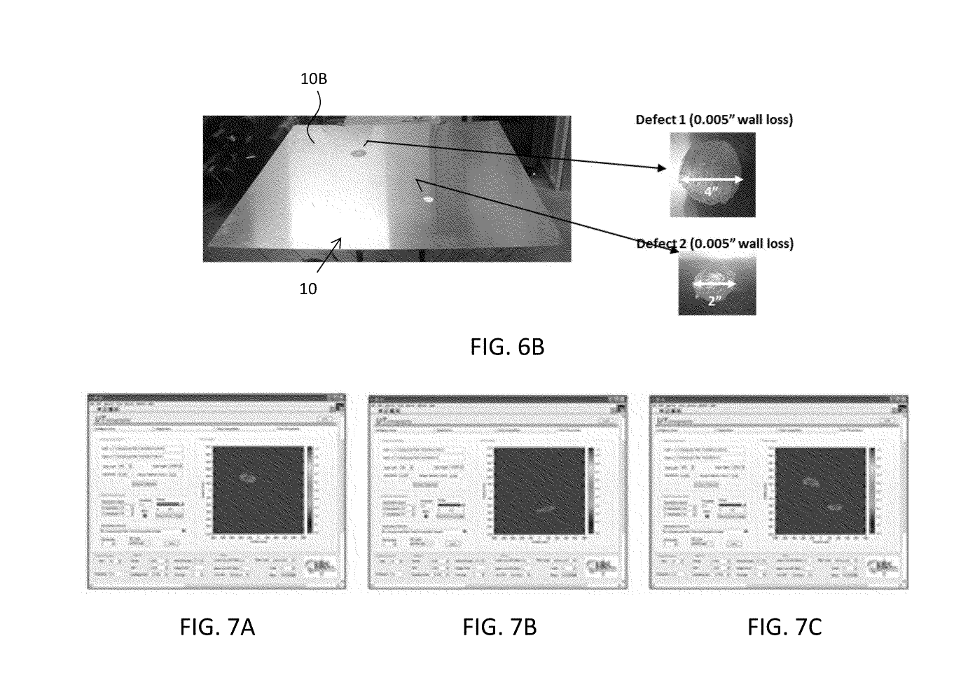

Referring now to FIGS. 10A and 10B, one example of a sensor 102A in accordance with some embodiments. Sensor 102 illustrated in FIG. 10A is implemented as a shear transducer and is based on a small shear polarized d₁₅ PZT element. The transducers/sensors 102A are designed for the excitation and reception of SH type waves. As best seen in FIG. 10A, transducer 102A includes a piezoceramic block 158 sized and configured to be received within an internal chamber defined by housing 160. Conductive leads 162, such as coaxial cable or other electrical wiring, are coupled to housing 160 and are disposed within a conduit 164 for electrical connection to a controller 130 (not shown). As can be seen in FIG. 10A, the size of sensor 102A is less than that of a dime. In some embodiments, piezoceramic block 158 is glued or fixed in housing 160 using a conductive epoxy, glue, or soldering. The internal chamber of housing 160 can be back filled with epoxy or soldering to improve the robustness of sensor 102A. An AC voltage 166 is applied to piezoceramic block 158 by conductive leads 162 as illustrated by the circuit diagram in FIG. 10B to provide shear deformations of the piezoceramic block 158.

Shear sensors 102A in accordance with FIGS. 10A and 10B were designed and tested using a fixed system 100 where the sensors 102A were fixedly coupled to plate or plate-like structure 10. These tests demonstrate that shear sensors 102A reduce and/or eliminate any negative effects, such as false alarms caused by water loading conditions, when performing guided wave SHM/NDE (nondestructive evaluation).

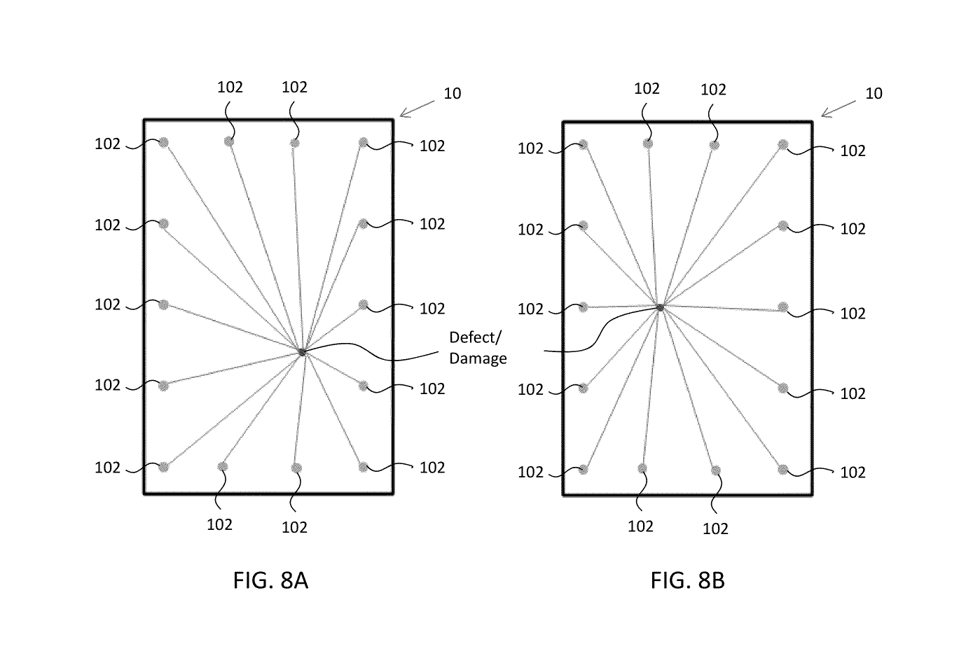

For example, FIG. 11A illustrates one example of a plurality of shear sensors 102A disposed on a surface of a plate 10 having a defect or damage in the form of corrosion thereon. FIG. 11B shows the results of performing SHM/NDE of the setup illustrated in FIG. 11B. As shown in FIG. 11B, a system 100 configured with shear sensors 102A was able to sense the corrosion on plate 10 as the corrosion is visibly presented in FIG. 11B.

FIGS. 11A and 11B are in contrast with FIGS. 11C and 11D, which illustrate a piezoelectric sensor setup under a water loading condition where the piezoelectric sensors were not d₁₅ PZT elements and the resultant image, respectively. As shown in FIG. 11D the water present on plate 10 in FIG. 11C triggered a false detection of corrosion that was not present in FIG. 11B.

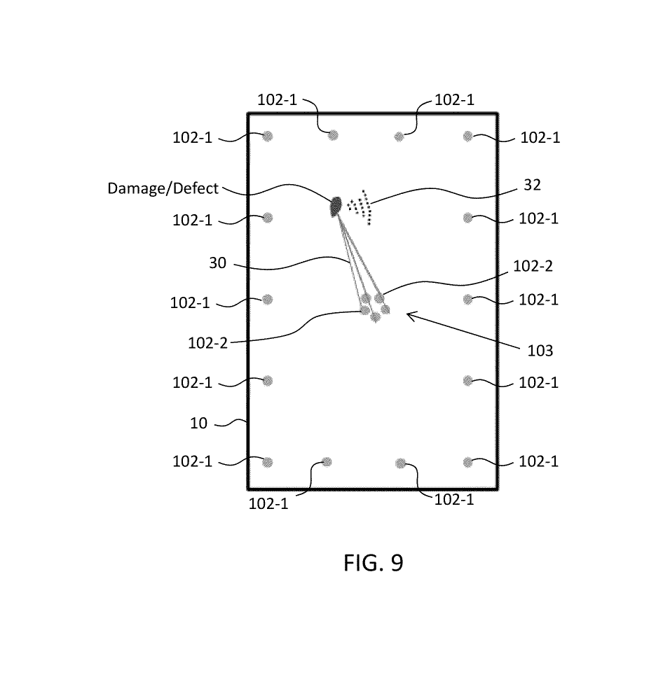

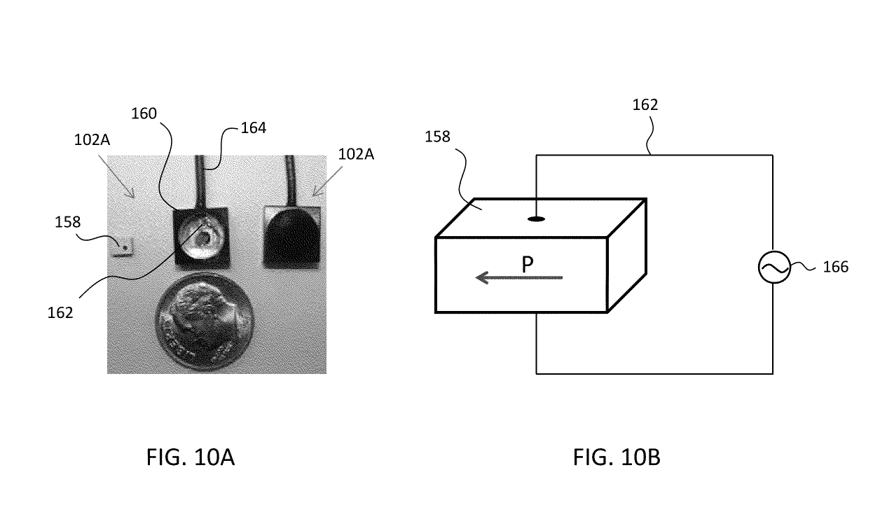

The shear polarized d15 PZT elements 102A can also be used to form a compact phased array for guided wave beam steering. For example, FIG. 12 illustrates an example shear PZT element array 103 disposed in a circular arrangement that is fixedly attached to a plate or plate-like structure 10. Each element 102A of the array 103 included a piezoceramic block 158 was mounted to the surface of a 0.375″ thick aluminum plate 10 that simulates a section of a ship hull. The results of the phased array defect detection of the setup illustrated in FIG. 12 for monitoring the growth of a corrosion defect are shown in FIGS. 13A-13D. The corrosion defect was simulated by pitting. The density of the pit holes was increased to simulate defect growth. Three defect growth stages were monitored. FIGS. 13A-13D present the phased array images for stages 1, 2, and 3 of the growth of the corrosion defect, respectively. The phased array data for FIGS. 13A-13C were collected when the plate was dry. FIG. 13D shows the phased array image for the corrosion defect at stage 3 with the plate 10 subject to water loading. Clear defect indications can be seen in all four figures. The locations of the defect indications also very well agree with the actual corrosion defect location.

As described above, the system 100 can be configured to be portable with a probe 105 including an array 103 of guided wave phased array sensors 102 as illustrated in FIG. 1B. In some embodiments, sensors 102 are formed from d₃₃ PZT elements, d₁₅ shear PZT elements, magnetostrictive transducer elements, or EMAT elements, to list just a few possibilities. Such a portable system 100 can be used for NDE of ship hulls or other structures comprising plates or plate-like structures.

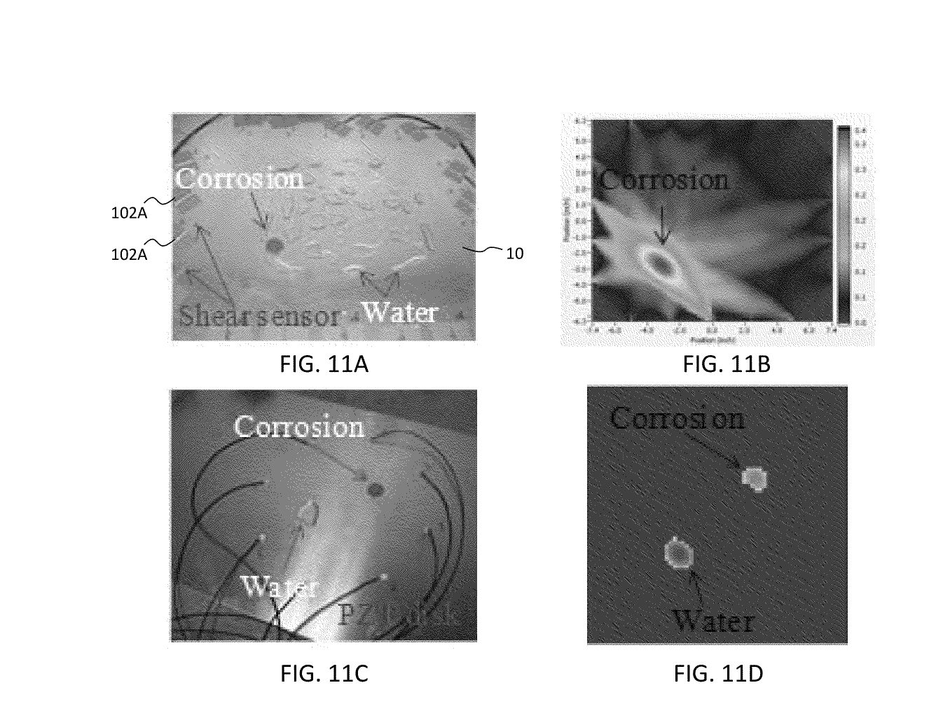

FIGS. 14A and 14B illustrate a pulse-echo phased array scanning image of a representation of a ship's hull. As shown in FIG. 14A, guided wave beam steering sends guided waves into different directions to look for defects, and FIG. 14B illustrates the defects identified by the probe. In pulse-echo mode, the transducers 102 of the phased array probe 105 detects defect reflections that propagate back to the probe position. The defect locations are determined by the beam steering angle, the time-of-flight (“TOF”) of the defect reflections, and the guided wave velocity. A pulse-echo phased array scanning image of the structure being inspected can be generated by varying phased array time delays to scan the regions of interest as shown in FIG. 14B. Such an image can be presented to a user on display 138 of controller 130.

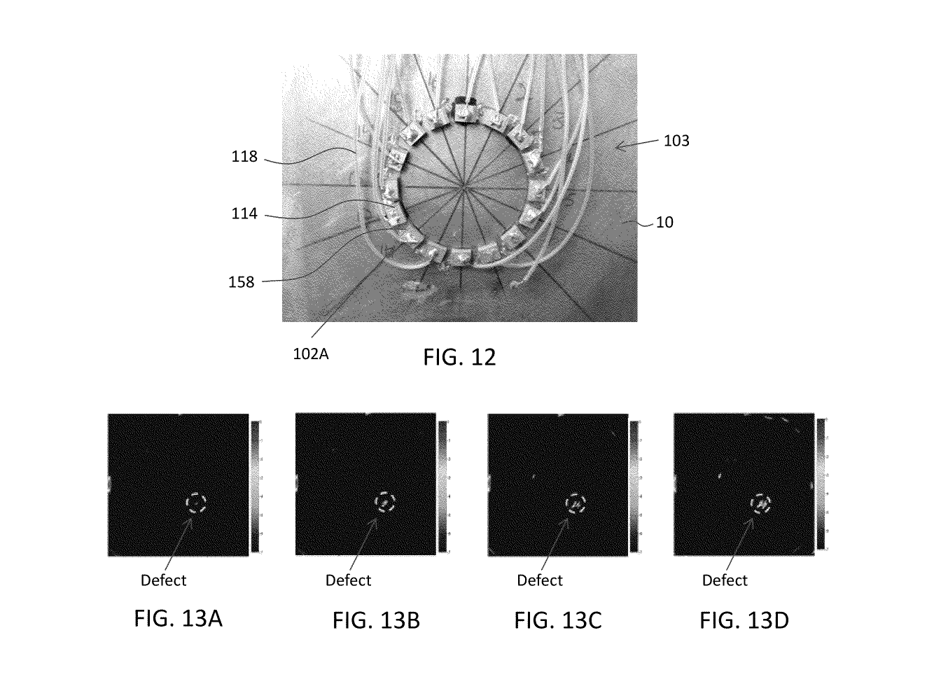

System 100 can be used for anisotropic multilayer composite plates or plate-like structures. As guided wave excitations become more complex when material anisotropy is involved, a Green's function based theoretical method can be employed to study the guided wave excitations in composite plate like structures as described in “Ultrasonic Guided Wave Phased Array for Isotropic and Anisotropic Plates,” by Yan. Amplitude and phase variations of the guided wave field excited by a point source applied normally to a composite plate are non-axisymmetric, but the point source itself can be considered as an axisymmetric loading. The angular dependencies of the amplitude for the mode 3 at 600 kHz and the mode 1 at 160 kHz calculated using the Green's function based method are shown in FIGS. 15A and 15B, respectively. As can be seen by comparing FIGS. 15A and 15B, the amplitude of the mode 3 changes much more dramatically as compared to the one of mode 1. The phased array beam steering directivity profile of a circular array for a composite plate can be calculated as:

$$p ( φ ) = {\sum }_{n}^{ } {α}_{g} ( φ ) exp \{ - i R [ {Φ}_{g} ( φ ) cos ( {ψ}_{n} - φ ) - {Φ}_{g} ( {φ}_{0} ) cos ( {ψ}_{n} - {φ}_{0} ) ] \} \qquad Eq . ( 5 )$$

### Where,

where α_{g}(φ) represents the angular dependence of the guided wave amplitude;

Φ_{g}(φ) is the corresponding angular dependence of phase variations,

R denotes the radius of the array,

ψₙ denotes the angular locations of the array elements, and

φ₀ is the beam steering angle.

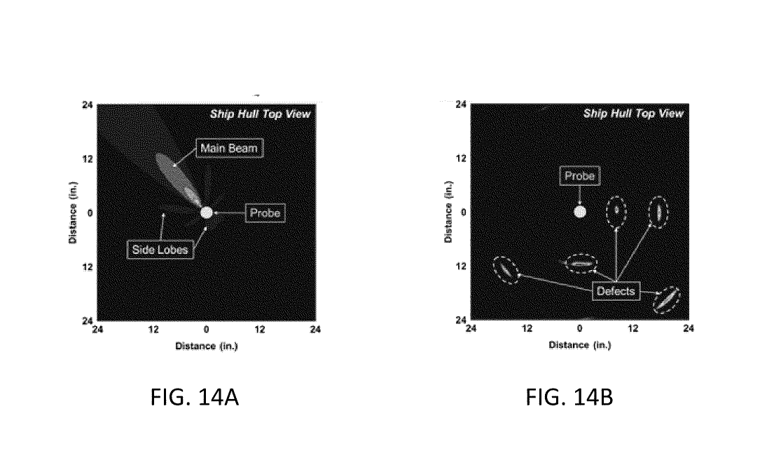

Sample directivity profiles for the mode 3 at 600 kHz and the mode 1 at 160 kHz are given in FIGS. 16A and 16B, respectively. From FIG. 16A, it can be seen that although the beam steering direction is 113 degrees, the strongest beam of the phased array output is close to the 150 degree direction, and the beam steering fails in other directions. The beam steering failure is due to the amplitude of the mode 3 reaching its minimum at the 113 degree direction as shown in FIG. 15A. The large amplitudes of the excited wave in other directions form strong side lobes.

In contrast, the mode 1 beam steering directivity profile for the 110 degree direction, which is the minimum amplitude direction for the mode 1, demonstrates a good beam steering capability in FIG. 16B. This is due to the fact that the amplitude variations of the mode 1 are much less severe than the mode 3. Thus, choosing the wave mode with less amplitude changes in different directions ensures good guided wave beam steering for all directions. Such selection can be made by reviewing the directivity profiles when developing signal processing and defect imaging algorithms.

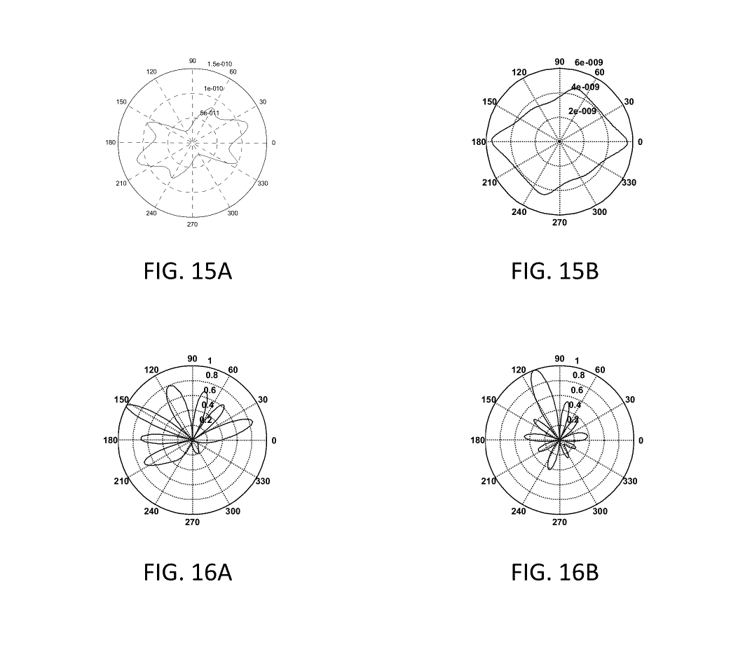

An example guided wave phased array probe 105, which includes a plurality of transducers 102 that are electrically coupled to a controller 130 (not shown), designed for beam steering in a composite plate is shown in FIG. 17. The composite array was designed for good beam steering directivity profiles for all directions in a 0.24 inch thick carbon composite plate. The mode 1 at 100 kHz was selected for such applications because the mode 1 is not sensitive to fiber orientations at low frequencies. As a result, the amplitudes of the mode 1 for different directions are close to each other.

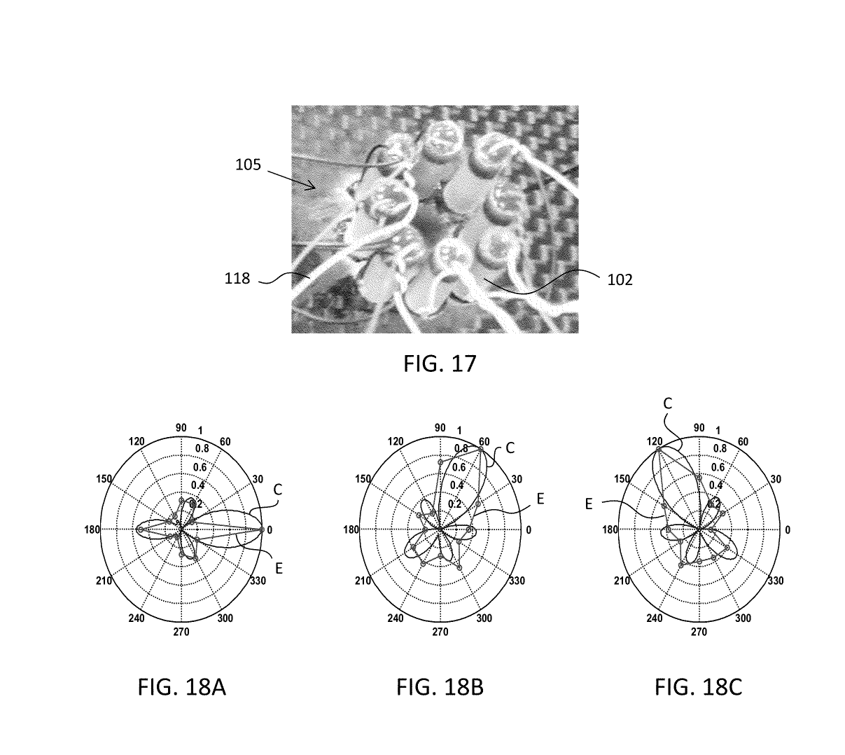

FIGS. 18A-18C illustrate comparisons between the measured directivity profiles of the array 103 and the theoretically calculated profiles. For example, FIG. 18A illustrates a comparison between experimental results (trace “E”) and a calculated array defectivity profile (trace “C”) for a beam steering angle of zero degrees. FIG. 18B illustrates a comparison between experimental results (trace “E”) and a calculated array defectivity profile (trace “C”) for a beam steering angle of 60 degrees, and FIG. 18C illustrates a comparison between experimental results (trace “E”) and a calculated array defectivity profile (trace “C”) for a beam steering angle of 120 degrees. As shown in each of FIGS. 18A-18C, the experimental results agreement well with the calculated array defectivity profile. Thus, an array as shown in FIG. 17 can be used to steer guided wave beams into any direction in the composite plate.

For some composite applications, guided wave energy can be focused in specific directions. In such applications, transducers 102 that excite guided waves with energy naturally focused to the desired directions are used. For composite materials with unknown material properties, multiple polar scans with different modes and frequencies may be applied to reduce effect of beam skewing, sidelobes, and to improve penetration power.

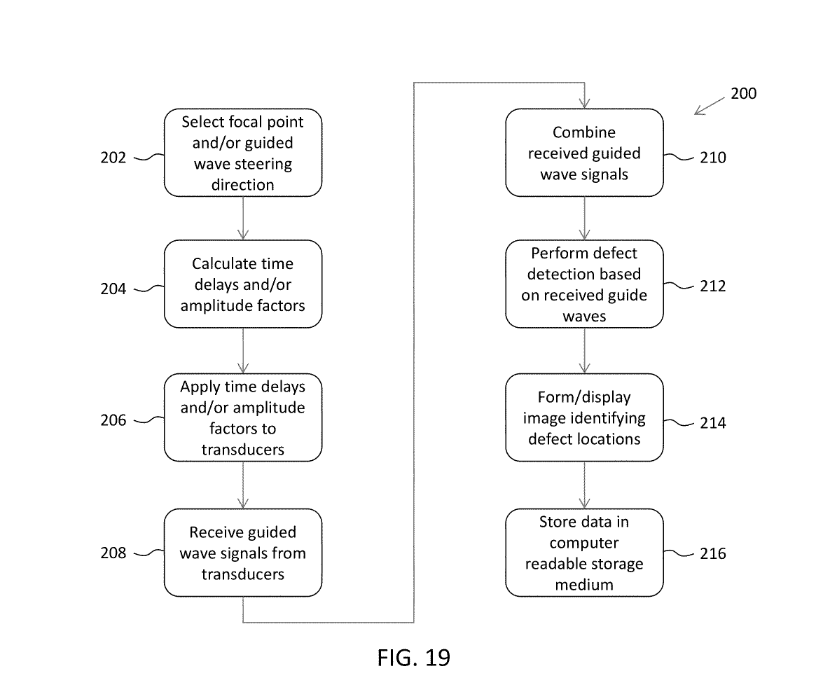

Turning now to FIG. 19, which is a flow diagram of one example of a method 200 of SHM/NDE of plates and plate-like structures using system 100, the operation and use of system 100 is described. At block 202, a focal point or guided wave beam steering direction on a plate or plate-like structure is selected. In some embodiments, for example, the focal point or guided wave beam steering direction is selected by a user. For example, a user can select a focal point or a guided wave beam steering direction to inspect a region of interest in the plate or plate-like structure. By changing the focal point or beam steering direction, method 200 can be repeated until a region of interest is completely inspected. In some embodiments, the selection of the guided wave beam steering direction is selected by system 100, which can be configured to automatically perform an inspection of the an entire region of interest by repeating method 200.

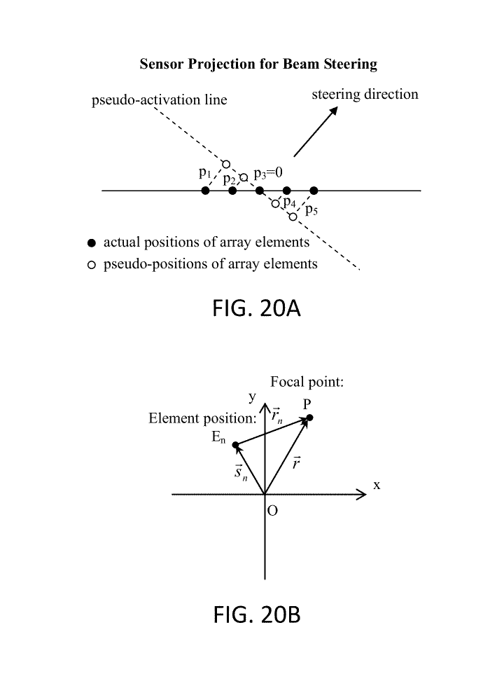

At block 204, time delays and/or possible amplitude factors are calculated. In some embodiments, system 100 calculates the time delays and/or amplitude factors and locations of the transducers. For example, time delays are applied to the array elements to achieve constructive interference in the beam steering direction for the purpose of beam steering. For example, FIG. 20A illustrates a wave path starting from an origin of a coordinate system as a reference. As shown in FIG. 20A, a time delay is used to compensate the phase difference from the wave generated by each element of the array. Letting Eₙ denote the position of the nth transducer, s̅ₙ denote the position vector from the origin to the nth transducer, φ̅ be the unit vector pointing to the steering direction, and c represent the wave velocity, the time delay for compensating the phase difference for the nth element can be written as:

$${Δ}_{n} = - \frac{\vec{φ} \cdot {\vec{s}}_{n}}{c}$$

Time delays are chosen to make the waves generated by all the transducers be focused at a focal point such that the waves arrive at the focal point at the same time. As illustrated in FIG. 20B, \vec{r}ₙ is the vector pointing from the nth transducer to the focal point P, \vec{r} and is the vector from the origin of the coordinate system to the focal point. The time delay for the nth array element can be calculated as:

$${Δ}_{n} = - \frac{\vert \vec{r} \vert - \vert {\vec{r}}_{n} \vert}{c}$$

At block 206, the calculated time delays and/or amplitude factors are applied to the array 103 of transducers 102 by controller 130. Transducers 102 are either fixedly connected and/or are disposed in a probe 105 that is placed in contact with a surface of a plate or plate-like structure. As described above, the plate or plate-like structure can be an anisotropic plate including, but not limited to, a multilayer fiber reinforced composite plate. In some embodiments, such as embodiments in accordance with the embodiment depicted in FIG. 9, additional transducers 102 other than those transducers 102 disposed in a probe 105 and/or provided in first array 103, are also placed on a surface of the plate or plate-like structure in an orderly arrangement or are placed randomly.

As described above, processor(s) 132 communicate with pulse generator 152 via communication infrastructure 134 causing pulse generator 152 to output control signals to transducers 102 in accordance with the time delays and/or amplitude factors. Transducers 102 cause one or more guided wave beams to propagate way from the array 103.

At block 208, reflections of the guided wave signals are received at one or more transducers 102 of array 103. In some embodiments, such as embodiments in accordance with the embodiment depicted in FIG. 9, additional transducers 102 other than those transducers 102 that generated the guided wave receive the reflected guide wave energy alone or in combination with the transmitting transducers 102. These additional transducers 102 can be disposed on the plate or plate-like structure in an orderly configuration or in a random configuration. The reflected signals received at transducers 102 are amplified by amplifier 154 and converted from an analog signal to a digital signal by A/D converter 156. The digital signal can be forwarded to processor(s) 132 via communication infrastructure 134 as will be understood by one of ordinary skill in the art.

At block 210, the received guided wave signals (e.g., reflected guided wave signals) are combined together. In some embodiments, the combination of the received signals is performed by processor(s) 132, which combine together the digital representation of the signals received from A/D converter 156 from communication infrastructure 134.

At block 212, the combined signals are used to perform defect detection by processor(s) 132. Possible defect reflections can be identified in the combined signals.

At block 214, an image of the plate or plate-like structure including an identification of a location of one or more defects is generated by processor(s) 132. In some embodiments, the generated image is displayed to a user on graphical interface/display 138, which receives signals from processor(s) 132 via display interface 136.

At block 216, the inspection data (e.g., defect location data and/or graphical representation data) are stored in a non-transient computer readable storage medium. For example, the data can be stored in main memory 140 and/or secondary memory 142 in response to processor(s) 132 transmitting the data via communication infrastructure 134.

The disclosed systems and methods described above advantageously enable SHM/NDE of plates and plate-like structures using guided wave phased arrays. The plates or plate-like structures can be anisotropic materials, including multilayer fiber reinforced composite materials, and can be dry or under water/liquid loading conditions. The transducers of the disclosed systems can be individually or simultaneously excited and can be placed closely together on the structure to form a compact array and/or distributed on the structure at some distance away from each other in a random or orderly configuration. In some embodiments, the transducers include shear d₁₅ PZT type transducers for generating and receiving SH-type guided waves for applications on structures subject to water loading conditions. The disclosed systems use a number of pulser and receiver channels into which time delays can be input.

Additionally the disclosed systems can be used to perform real-time phased array beam steering and/or focusing utilizing guided wave transducers with mode and frequency selection capability for guided wave phased array and/or CT testing. Physically based guided wave features can be extracted from guided wave signals for damage detection and evaluation.

In some embodiments, the systems are configured to perform guided wave phased array tests or guided wave CT tests individually. In some embodiments, the systems also are configured to combine the guided wave phased array approach with the guided wave CT approach.

The disclosed systems and methods can be at least partially embodied in the form of program code embodied in tangible media, such as floppy diskettes, CD-ROMs, DVD-ROMs, Blu-ray disks, hard drives, or any other tangible and non-transient machine-readable storage medium, wherein, when the program code is loaded into and executed by a machine, such as a computer, the machine becomes an apparatus for practicing the method. The disclosed systems and methods can also be embodied, at least partially, in the form of program code, for example, whether stored in a storage medium, loaded into and/or executed by a machine, or transmitted over some transmission medium, such as over electrical wiring or cabling, through fiber optics, or via electromagnetic radiation, wherein, when the program code is loaded into and executed by a machine, such as a computer, the machine becomes an apparatus for practicing the methods. When implemented on a general-purpose processor, the program code segments combine with the processor to provide a unique device that operates analogously to specific logic circuits.

Although the disclosed systems and methods have been described in terms of exemplary embodiments they are not limited thereto. Rather, the appended claims should be construed broadly, to include other variants and embodiments of the disclosed systems and methods, which may be made by those skilled in the art without departing from the scope and range of equivalents of the systems and methods.

What is claimed is:

1. An ultrasonic guided wave system for defect detection in a plate-like structure, comprising:
at least two guided wave transducers configured to be disposed on a plate; and
a controller electrically coupled to the at least two guided wave transducers, the controller including
a machine readable storage medium, and
a processor in signal communication with the machine readable storage medium, the processor configured to
cause a pulse generator to pulse the at least two guided wave transducers in accordance with at least one of time delays or amplitude controls such that guided wave energy is steered in a predetermined direction in the plate or is focused at a predetermined focal point,
process at least one reflected guided wave signal to identify a location of at least one possible defect in the plate, and
have defect detection data of the plate including the location of the at least one possible defect in the plate stored in the machine readable storage medium.

2. The system of claim 1, wherein the at least two transducers are disposed in a housing to form a portable multi-element probe.

3. The system of claim 1, wherein the at least two transducers are coupled to the plate-like structure.

4. The system of claim 1, wherein at least one of the at least two transducers is a shear polarized d₁₅ piezoelectric transducer.

5. The system of claim 1, wherein at least one of the at least two transducers is a magnetostrictive transducer.

6. A method for ultrasonic guided wave defect detection in a plate-like structure, comprising:
a) driving a plurality of transducers to cause guided waves to be transmitted in the plate-like structure in a predetermined direction or focused at a predetermined focal point;
b) receiving at least one reflected guided wave signal;
c) processing the at least one reflected guided wave signal to identify a location of at least one possible defect in the plate-like structure; and
d) storing defect detection data including the location of the at least one possible defect in the plate-like structure in a machine readable storage medium.

7. The method of claim 6, further comprising:
e) determining at least one of the direction in which the guided waves are to be transmitted in the plate-like structure or the focal point at which the guided waves are to be focused; and
f) calculating at least one of a time delay or an amplitude for a control signal for driving at least one of the plurality of transducers.

8. The method of claim 7, wherein the calculating includes amplitude and velocity variations of guided wave energy generated by a single transducer are included in the time delay and amplitude factor calculations for focusing the guided wave energy at the focal point or steering the guided wave energy into the beam steering direction.

9. The method of claim 6, further comprising repeating steps a), b), c), and d) for different predetermined locations.

10. The method of claim 6, wherein a plurality of reflected of guided wave signals are received, the method further comprising combining the received guided wave signals using back propagation signal synthesis.

11. The method of claim 6, further comprising:
generating an image identifying the at least one possible defect; and
displaying the image.

12. The method of claim 6, wherein the plurality of transducers are disposed on the plate-like structure at a distance from one another.

13. The method of claim 6, wherein the plurality of transducers are disposed on the plate-like structure and form a compact array.

14. The method of claim 6, wherein the plate-like structure includes a multilayer fiber-reinforced composite plate.

15. The method of claim 6, where in the transducers are driven such that guided waves are insensitive to an anisotropy of the plate-like structure.

16. A system for ultrasonic guided wave defect detection in a plate-like structure, comprising:
a first sensor, including:
a housing defining an internal chamber;
a block of d₁₅ piezoelectric material configured as a shear transducer disposed within the internal chamber defined by the housing; and
at least one conductive trace electrically coupled to the block of d₁₅ piezoelectric material and configured to couple the block of d₁₅ piezoelectric material to a voltage source for generating shear deformations of the block of d₁₅ piezoelectric material.

17. The system of claim 16, further comprising a second sensor, the second sensor including:
a second housing defining a second internal chamber;
a second block of d₁₅ piezoelectric material configured as a shear transducer disposed within the second internal chamber defined by the second housing; and
at least one second conductive trace electrically coupled to the second block of d₁₅ piezoelectric material and configured to couple the second block of d₁₅ piezoelectric material to the voltage source for generating shear deformations of the block of d₁₅ piezoelectric material.

18. The system of claim 16, wherein the housing defines a plurality of internal chambers each being disposed at a distance from the other internal chambers.

19. The system of claim 18, further comprising a plurality of blocks of d₁₅ piezoelectric material configured as a shear transducer, each of the plurality of blocks of d₁₅ piezoelectric material being disposed within a respective one of the internal chambers defined by the housing.

20. The system of claim 16, wherein a plurality of blocks of d₁₅ piezoelectric material configured as a shear transducers are disposed within the internal chamber defined by the housing of the first sensor.
